(19) United States
(12) Patent Application Publication
(10) Pub. No.: US 2021/0312384 A1
(43) Pub. Date: Oct. 7, 2021

(54) Condition-Precedent Temporal-Based Actuator For Package Delivery System

(71) Applicant: Front Porch Ventures, Inc., Vestavia Hills, AL (US)

(72) Inventor: Patrick Campbell, Vestavia Hills, AL (US)

(21) Appl. No.: 17/222,630

(22) Filed: Apr. 5, 2021

Related U.S. Application Data
(60) Provisional application No. 63/006,074, filed on Apr. 6, 2020.

(51) Int. Cl. G06Q 10/08; G06F 9/54; G06F 16/51; G07C 9/00

(52) U.S. Cl. CPC G06Q 10/0833; G07C 9/00896; G06F 16/51; G06F 9/54

(57) ABSTRACT

A package delivery method, or method for access to a secured space, of recording in a delivery service database a time of a delivery of a package at a delivery site, and then entering a package code to a data receiver at the delivery site, which package code communicates to the delivery database; and the secured space opens upon confirmation that entry of the package code to the data receiver is within a predetermined period of the delivery time associated with the package code. A package delivery system and a container for receiving delivery of a package are disclosed.

### TECHNICAL FIELD

The present invention relates generally to releasing actuators for accessing secured spaces. More particularly, the present invention relates to actuators that selectively operate to provide access by an event servicer to a secured space of a receiving party upon determination of at least one unscheduled condition-precedent event within a temporal occurrence period.

### BACKGROUND OF THE INVENTION

Commerce is increasingly transitioning from a brick-and-mortar physical plant distribution system to a network-based product presentation/customer selection and order system with product distribution via third party order fulfillment and distribution delivery. Traditional retail commerce involves individual consumers travelling to retail centers such as shopping centers and stores for selecting and purchasing product items, receiving the selected product items, and returning to respective homes or businesses with the selected product items. The transition however allows consumers to view and order products presented through on-line stores. The on-line stores replicate within a networked environment offering of goods and services. The goods offered by a store are typically displayed on a web page with an image of the goods and with text information as to the details of the particular goods. The web page includes a “add-to-cart” or similar button configured with software instructions to arrange for purchase of the goods when selected by the customer. The arrangement for purchase obtains the customer name, address, payment information, and shipping address. The seller then schedules the goods for delivery through one of a number of package delivery services. Often the particular order has a tracking number with which the customer may track the transport and delivery of the products.

While some deliveries may be subject to signature-on-receipt requirements for proof of delivery, many packages are delivered onto porches or near front doors of designated residence of the customer. For a long time, this was satisfactory. However, the growth of ship-to-customer networked commerce has significantly increased, and with that growth has developed package thefts. Persons follow delivery trucks and snatch packages that are left by the delivery service. The customer then believes the package was not delivered, not shipped, or was lost. This costs the customer time in seeking a replacement for the order. Stolen packages cause financial loss to the seller in replacing products shipped but not received by the customer.

On-line retailers have developed alternatives. This includes shipping to an address at which persons are available to receive the packages. Some employers however are unwilling for employees to ship personal packages to the company mailroom, as adding responsibility and costs. Other alternatives include shipping products to a delivery service locker from which the customer may retrieve the order using a code supplied by the delivery service. Many consumers however prefer receiving packages at residence addresses.

Accordingly, there is a need in the art for an improved system for delivery of product items by delivery servicers to a secured space of a receiving party. It is to such that the present invention is directed.

### BRIEF SUMMARY OF THE INVENTION

The present invention meets the need in the art for an improved system for delivery of product items by delivery servicers to a secured space of a receiving party. The delivery system provides a temporal-based actuator system with a condition precedent of the package carrier updating a package tracking system with the delivery date and time associated with the package identified by a package code. The package carrier then enters the package code, such as by scanning a bar code, at the secure container. A controller communicates the attempted delivery date and time to the tracking system. The tracking system compares the attempted delivery date and time with the delivery date and time entered earlier by the delivery carrier. If the attempted delivery is within a predetermined period, the tracking system indicates the status of the package verification request as valid. The controller upon receipt of the status instructs the container to open. If the status is invalid, the controller does not instruct the container to unlock and open.

The present invention meets the need in the art by providing a method for delivery of a package to a secured space of a receiving party, comprising the steps of:

(a) recording in a delivery database a temporal characteristic associated with a proximate delivery of a package having a package code identifying the package to be delivered at a delivery site;

(b) entering the package code to a data receiver of a secure space at the delivery site for requesting the secure container to open;

(c) communicating with a network communicator of the secure space the package code to the delivery database; and

(d) opening the secured space for receiving the package upon receiving from the delivery database confirmation of a determination that entry of the package code to the data receiver is within a predetermined period of the temporal characteristic associated with the package code.

In yet another aspect, the present invention provides a package delivery system, comprising a delivery communicator configured for communicating to a package database a temporal characteristic associated with a proximate delivery of a package having a package code identifying the package to be delivered at a delivery site. A delivery service network communicator receives the communication from the delivery communicator and records in a delivery database the temporal characteristic in association with the package code. A data receiver of a secure container at the delivery site receives an entry of the package code as a request to open the secure container. A network communicator of the secure container communicates the package code to the delivery service network communicator and receives from the delivery service network communicator a confirmation of a determination that entry of the package code to the data receiver is within a predetermined period of the temporal characteristic associated with the package code. A releasable latch biased to a locked position securing the secure container from opening may selectively move to an unlocked position to allow opening the secured container for receiving the package.

In yet another aspect, the present invention provides a container for receiving delivery of a package, comprising a secure container selectively opened for receiving delivery of a package at a delivery site. A data receiver receives an entry of a package code identifying a package for delivery, said entry for requesting the secure container to open. The secure container includes a container network communicator. The secure container includes a releasable latch biased to a locked position securing the secure container from opening and selectively moved to an unlocked position to allow opening the secured container for receiving the package in response to a key. A controller (a) communicates with the container network communicator a time code associated with the entry of the package code to a package tracking database for each of a plurality of packages identified by a respective package code and having an associated temporal characteristic of a respective proximate delivery time of the package to be delivered at a delivery site and (b) receives a confirmation of a determination that entry of the package code is within a predetermined period of the temporal characteristic associated with the package code, whereby the controller causes the releasable latch to move to the unlocked position for opening the secured container for receiving the package.

Objects, advantages, and features of the present invention will become readily apparent upon a reading of the following detailed description in conjunction with the drawings.

### BRIEF DESCRIPTION OF THE DRAWINGS

FIG. 1 provides a schematic illustration of a package delivery system according to the present invention.

FIG. 2 provides a process flow for the package delivery system according to the present invention.

FIG. 3 illustrates a secure container for a package delivery system according to the present invention.

### DETAILED DESCRIPTION

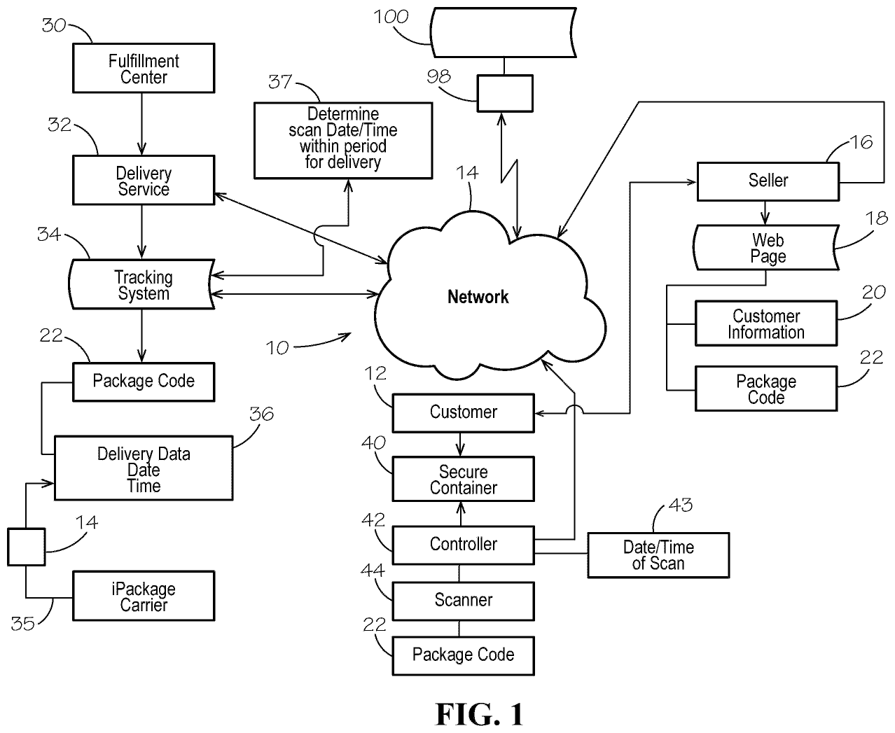

FIG. 1 provides a schematic illustration of a secure space access system, and particularly for an illustrative package delivery system 10, according to the present invention. A customer having a microprocessor computer 12 configured with a network communication device communicates through a network 14 to access a selected one of a plurality of on-line seller store web sites 16. The web site 16 includes a plurality of web pages 18 for products offered by the on-line seller store site. Using conventional systems, the customer may selectively purchase a selected product such as using a “add-to-cart” button. The purchase transaction conventionally obtains the customer information 20 including name, address, payment information, and delivery information including a delivery address. The order is provided with an order or package code 22.

The seller may self-fulfill the order or provide the sales information to an order fulfillment service generally order fulfillment 30. The order fulfillment service 30 arranges for transport and delivery by a delivery service 32. The delivery service 32 conventionally includes a tracking computer system 34 for following or tracking the receipt of the package from the fulfillment service 30, handling and location of the package in transit, and delivery information at the delivery address. The package carrier often a driver operating a delivery truck handles the “last mile” transfer of the package to the delivery address. The package carrier updates the tracking computer system 34 with the delivery data 36 such as delivery date and time.

In accordance with the present invention, the customer provides a secure locked container 40 equipped with a microprocessor controller 42 and a network communicator. The secured container 40 includes a scanner device 44.

The delivery truck is equipped with a network communicator for communicating through the network 14 with the tracking system 34. At delivery, the package carrier first updates 35 the delivery service tracking system 34 with the delivery information 36 including date and time. The package carrier then carries the package to the secure container 40. The package carrier uses the scanner 44 to scan the package code 22. The controller 42 uses the package code 22 to identify the delivery service 32 and access the tracking system 34. The controller 42 provides its container identification number and the current date and time 43 at which the scan occurred. This date and time is the time at which the delivery carrier is attempting to open the container 40. The controller 42 obtains the date and timer from its internal clock or from a clock system of the system provider 98. The controller 42 communicates the scanned package code and temporal data (date and time) of the scan through the network to the tracking system 34 of the delivery service. A determiner of the tracking system 34 compares the current date and time with the delivery data 36 and determines 37 a status of the request. If the communicated date and time of the scan is within a predetermined parameter of the delivery data 36, the tracking system reports an approved status to the controller 42. The controller 42 may then unlock the container 40. The package carrier may then insert the package into the container 40. The package carrier then closes the container 40 which again locks against unauthorized opening.

The customer has a pre-arranged user code that upon scanning with the scanner 44, directs the controller 42 to open the container 40. Thus, the customer may then later enter the user code to the scanner 44 for opening the container 40 and retrieving the package. The system therefore restricts access to the container 40 if an inappropriate person attempts to open the container with another package identifier.

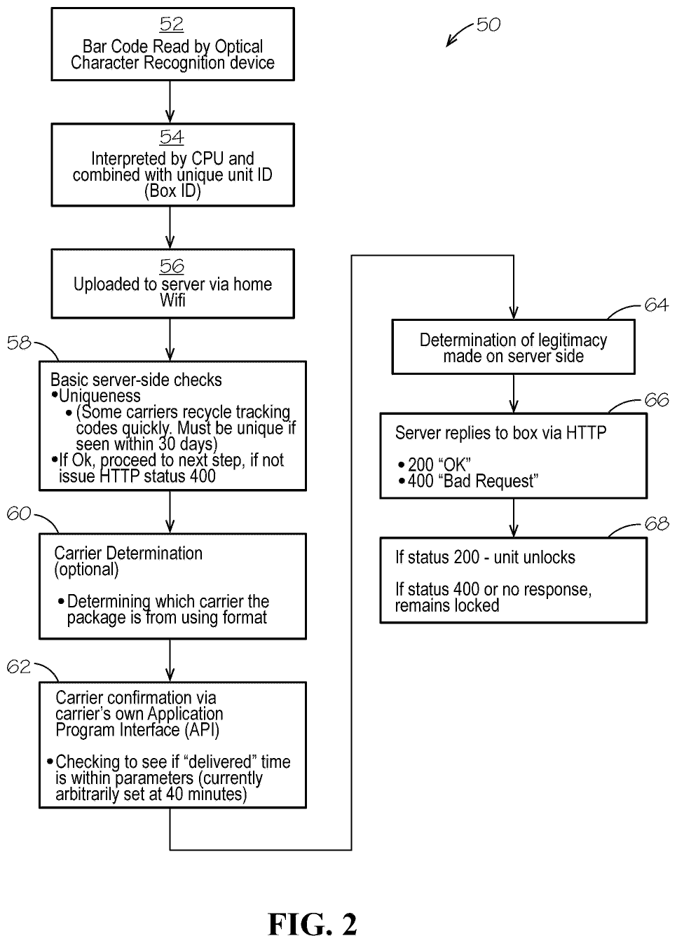

FIG. 2 illustrates a process flow 50 for the package delivery system 10 according to the present invention. The scanner 44 reads 52 the package code 22 such as a bar code printed on the container or on a label attached to the container, and communicates the package code to the controller 42. The controller associates 54 the package code 22 with a unique container code (box ID). The controller interlinks 56 to the network 14 preferably through a local router such as a home WiFi system. The controller 42 may provide server-side checks 58 for verification and validity. For example, the controller may evaluate the package code for uniqueness.

The controller determines 60 which delivery service 32 is carrying the package. Each delivery service is provided with unique identifiers or format for the package code. The controller 42 contacts the tracking system 34 and transmits the current delivery date and time of the scan 43. The delivery service uses 62 an API (application program interface) to compare 37 the communicated delivery date and time provided by the controller 42 with the tracking system delivery data 36. If the “delivered” data from the controller 42 is within a predetermined time parameter, the tracking system determines 64 the status of the request from the controller 42 as legitimate. The predetermined time period is an amount of time provided for the package carrier to leave the truck and deliver the package. For example, the predetermined time period may be a range of one minute to an hour, and in the illustrated embodiment, a predetermined time period is 40 minutes.

The tracking system 34 communicates 66 through the network 14 to the controller with a status code. The status code indicates whether the request is legitimate or not. If legitimate, the controller 42 instructs 68 the latch on the container 40 to release in order for the container to open for insertion of the package. If the status code is invalid, the controller 42 ends the process and does not release the latch on the container.

The present invention provides a secure receiver for example, a portal, container, or space, of a receiving party, which is secured by a lockable releasable actuator for accessing the secure receiver biased locked or closed to access and openable, releasable or movable to open position for access based upon validation of the occurrence of an action by a service provider and an attempted opening within a predetermined period relative to occurrence of the action. The service provider such as a delivery carrier or vehicle driver having the code that is marked on the package for delivery enters the action event (i.e., ready to deliver the package to the receiving party) to the tracking system based on the code. The tracking system records the package data of the date and time of the action event. The delivery carrier then transports or carries the package to the secure receiver for depositing the package in the secure receiver. The secure receiver includes a sensor for receiving a code request for access, for example, a scanner device, but alternatively a keypad or other command input device for communicating the package code to a controller. The controller communicates a receiver identification together with the coded package shipping identification number to the tracking system for the service provider and the date and time of the scanned request to open the locked receiver. The controller communicates the information through a network, for example, by accessing a local WiFi communications device or other network accessing device. The tracking system validates the request by locating the data record for the package indexed by the package shipping identification number. If the request for access is within a predetermined period of the action event, the tracking system responds with a status that authorizes the controller to open the secure receiver.

The present invention accordingly involves obtaining carrier confirmation via an API that the package associated with the bar code scanned by the driver has a “delivery time” proximate the time that the bar code was scanned by the driver to indicate the occurrence of the delivery action event. The scan time (requesting access to the secure container) must be within a predetermined period relative to the carrier delivery time, in order for the secure package-receiving container to open. The system in the illustrated embodiment sets the predetermined period to 40 minutes (i.e., the carrier delivery time and the time of the scan must be within 40 minutes). In one embodiment, a recipient using the secure delivery system may select a different period (for example, but not limited to a time in a range from 1 minute to 24 hours, or selectively longer) for the temporal-based authenticating of the request to open the secure container. In an alternate embodiment, a delivery service may similarly select an appropriate time period for the temporal-based authentication. For example, a delivery service at a busy period may modify the pre-determined interval as needed to meet business needs. In such application, such as during a holiday season, delivery carriers may mark packages as “delivered” prior to beginning the travel of the delivery route, as it may be the delivery service would be seeking to save processing time during each individual delivery over the course of the delivery day. The delivery service may in such illustrative event set the period for temporal-based authentication to a 10-hour period. The time period accordingly may be set selectively to an appropriate time period for the particular application.

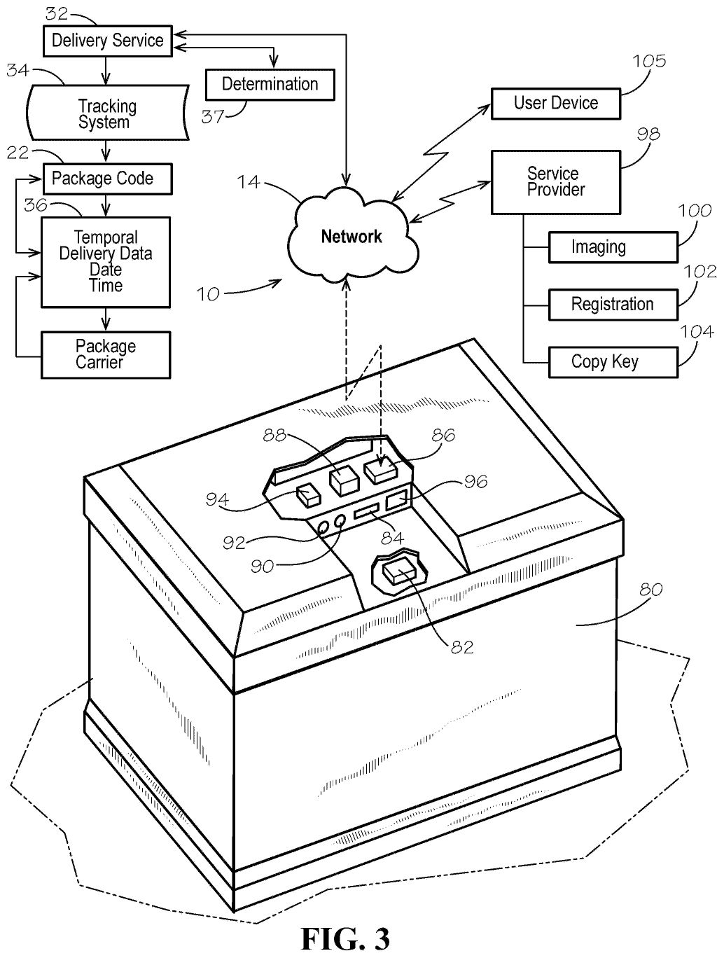

FIG. 3 illustrates an illustrative embodiment of a secure space configured for a package delivery system according to the present invention in the form of a container 80. The secure container 80 is suitable for placing outside a building or house, for receiving delivery packages. The secure space however may be a building, office, vault, lockers device, or other entrance-controlled space for periodic reception or access for ingress or removal, under a condition-precedent temporal-based actuator system. The secure container 80 comprises a housing having a bottom, opposing front and back, and opposing sides, with a cover. In the illustrated embodiment, the cover is hinged for opening and includes a releasable latch 82. The releasable latch 82 is biased to a locked position securing the secure container 80 from opening and selectively moved to an unlocked position to allow opening the secured container, in response to a notice and verification in accordance with the present invention. In the illustrated embodiment, the releasable latch 82 is an electrotechnical solenoid latch. A hook mounts to an upper edge of the container 80. A lock includes a slot that receives the hook. The lock includes a displaceable retracting/extending pin that upon activation detaches the lock from the hook. A suitable releasable latch is available from various suppliers including model VE-P201 available from Alibaba product supply web site. Other conventional electromechanical solenoid latches may be used.

The secure container 80 includes a data receiver 84 for receiving an entry of a package code identifying a package for delivery. The entry of the package code defines a request for the secure container to open. The data receiver 84 in the illustrated embodiment is a bar code scanner for imaging package codes printed on packages or on labels attached to packages. The secure container 80 includes a network communicator 86 for receiving and communicating through a telecommunications network. The network communicator may a wireless device for remotely connection to a telecommunications network, or alternatively, may be direct wired such as with an Ethernet connection wire, CAT5e, or similar. A microprocessor controller 88 includes software instructions for operating the secured container. The controller 88 (a) communicates using the container network communicator 86 a time code associated with the entry of the package code 22 to the package tracking database 34 of the package delivery service 32. The package tracking database 34 includes status information for each of a plurality of packages identified by the respective package code 22 and has the date field 36 for receiving and holding an associated temporal characteristic of a respective proximate delivery time of the package to be delivered at a delivery site. The controller 88 also receives a confirmation of a determination that entry of the package code is within a predetermined period of the temporal characteristic associated with the package code, whereby the controller 88 causes the releasable latch 82 to move to the unlocked position for opening the secured container 80 or receiving the package. A motion detector 90 detects motion proximate the container 80 and activates the data receiver 84.

Optionally in an alternate embodiment, the secure container 80 includes an imaging device 92 for imaging for a predetermined period upon activation of the data receiver. The imaging depicts the person or persons and package delivery operations proximate the secure container 80. The images may be stored in electronic memory local to the secure container or streamed as an upload communication with the container network communicator 86 to a remote electronic storage device (not illustrated). In this embodiment, a separate microprocessor 94 operates the imaging and storage functions. System users may log in to a web portal for access to the images.

In yet another alternate embodiment, the imaging device 92 is configured for package code recognition and thus, the separate bar code scanner (data receiver 84) is not necessary.

The illustrated embodiment uses two microprocessors 86, 94. The first microprocessor 86 is configured for the container unlocking process while the second microprocessor 94 is dedicated to video imaging and upload services. The motion sensor 90 is always on. (In the illustrated embodiment, a battery for supply of power is not illustrated; such battery is preferably a long-life device, and may be connected to a solar panel (optional and not illustrated) to maintain a capacity for the battery). In an implementation, the microprocessors 86, 94 upon powering up, are active for a predetermined period of 2 minutes and if no motion is then detected, the microprocessors enter a sleep mode with the container network communicator 86 turned off. When motion is detected, the microprocessors are awakened and the data receiver 84 is powered on.

Optionally in an alternate embodiment, the container 80 further comprises a display screen 96, such as an LCD display device, for displaying a key code generated by the microprocessor controller operations software instructions for imaging with a mobile communications device 105 for use in subsequent requests to open the container 80. The key code enables a registered user to access the secured container 80 by imaging the key code on the mobile communications device and scanning the key code with the data receiver. The controller is further configured to receive the key code and, upon verification cause the releasable latch to move to the unlocked position for opening the secured container.

For use, the secure container 80 in the illustrated embodiment is registered with service provider 98 having a central database 100 for use of the secure container 80 the package receiving method in accordance with the present invention for securely in receiving packages. Registration in the illustrated embodiment uses a web site application 102 for authenticating the controller system to the package tracking and delivery system of the provider 98. As with other subscription-based or service provides, the system includes in registration 102 web pages for a user of the package delivery system to identify the one or more persons for using the secure container 80 to retrieve packages, identify the network connection for the network communicator 86, and generate and display the user digital code for the access key. Upon accessing the provider 98 web site, such as a database portal, an initial screen displays on a mobile communications device or desktop computer for registration. The mobile communications device may image the LCD display that, upon initial startup or perhaps lost connectivity, indicating that the secure container is not connected through the container network communicator 86 to a telecommunications network and that setup needs to be completed. Conventionally, the provider 98 receives and stores a log-in and password, and also user information (name, address, email). The user provides the communication network identifier and password allowing the container network communicator 86 to access the network 14 (represented in FIG. 3 by a dashed line therebetween). The provider 98 than generates a digital user code that is displayed on the LCD 96 (or computer screen if registering in an alternate embodiment through a desktop computer). The user may then scan or image the digital code to save to the mobile communications device or alternatively forward the digital code or a link, such as through an email or messaging system.

In an alternate embodiment, the use may access the provider 98 registration web site 102 to generate 104 a supplemental or temporary key code to be shared with another person, for example, a one-time use “temporary” key code for a neighbor. The user logs-in with user name and password established during registration and selects a “make a copy” feature. The copy process includes entry of a name for a copied key, a time range during which the copy key is to be functional or, alternatively, set for a one-time use. A digital code such as a QR code is displayed and the image may be recorded by imaging or scanning with a mobile communications device. Alternatively, the supplemental digital code may be forwarded, or alternatively, copied as a link and forwarded in an email or text messenger application.

With reference to FIG. 3, the secure container 80 is used by a package carrier for delivery of a package containing a product ordered by the recipient from the seller 16. Upon reaching the delivery address, the delivery carrier scans the package and a communications device uploads 35 the delivery date and time to the tracking system 34. The delivery carrier than carries the package to the point of delivery. The carrier sees the secure container 80. The container 80 may include instructions for access to the container. The motion detector 90 senses motion of the carrier near the container 80 and activates the receiving system. The carrier scans the package code 22 with the scanner 84. The controller 88 determines the temporal data (date and time) for the scan, and communicates the package code and scan date and time using the network communicator 86 to the delivery service 32. The tracking system 34 of the delivery service determines 37 whether the scan date and time is within a predetermined period of the delivery date and time provided 35 by the package carrier. In an embodiment equipped with the video camera 92, the controller 94 operates the imaging device 92 and uploads images or video of the activity for storage 100. The delivery service 32 returns an authorization to the controller 88, for release operation of the latch 82, for opening the lid or door of the secure container 80 for insertion of the package (or packages). Upon closing the lid, the latch 82 re-locks the secure container 80.

A user later accesses the secure container 80. The motion detector 90 senses the activity and activates the controller 88 for accessing the container and the controller 94 for imaging the activity. The user displays the digital code or key such as on a display of a mobile communications device, and the scanner 94 scans the digital code. The scanned digital code is validated, and if valid, the latch 82 of the secure container is released for opening the lid (or door) of the container 80 for removal of the package(s). The controller 88 may hold one or more authorized digital codes or keys for local determination of the validity of the presented digital code, or alternatively, the controller 88 may communicate the scanned digital code with the communicator 88 to the service provider 98 for validation against the registration database 102.

The present invention accordingly provides a selectively opened secure container based on (a) a condition precedent of the package carrier updating a delivery service package tracking system with the action event delivery date and time and (b) a temporal validation of the scan of the package code at the secure container within a predetermined period relative to the delivery date and time recorded in the package tracking system.

The foregoing discloses illustrative embodiments of a condition precedent temporal time-based access system, and particularly in an illustrative embodiment, a package receiving storage system having secured access with package servicer delivery statement and verification for opening the secure space yet the recipient may readily gain access to the received packages. It is to be appreciated that the present invention may be gainfully employed in other applications for opening a secured space of a receiver based on a condition precedent event established by an event servicer and a request for opening occurring within a predetermined period of the event. The forgoing written description enables one of ordinary skill in the art to practice the invention in disclosed embodiments as well as making and using alternative embodiments within the scope of the claims.

What is claimed is:

1. A method for delivery of a package to a secured space of a receiving party, comprising the steps of:
(a) recording in a delivery database a temporal characteristic associated with a proximate delivery of a package having a package code identifying the package to be delivered at a delivery site;
(b) entering the package code to a data receiver of a secure space at the delivery site for requesting the secure container to open;
(c) communicating with a network communicator of the secure space the package code to the delivery database; and
(d) opening the secured space for receiving the package upon receiving from the delivery database confirmation of a determination that entry of the package code to the data receiver is within a predetermined period of the temporal characteristic associated with the package code.

2. The method as recited in claim 1, wherein the temporal characteristic comprises a date identifier and a time identifier.

3. The method as recited in claim 2, wherein the time identifier comprises an hour component and a minute component corresponding to a time proximate and prior to the step of entering the package identifier to the data receiver.

4. The method as recited in claim 1, wherein the communication from the network communicator includes a transmission time identifier; and
a controller receiving the communication from the secure container determines whether the transmission time identifier is within the predetermined period of the temporal characteristic.

5. The method as recited in claim 1, wherein the determination is via an API.

6. The method as recited in claim 1, wherein the predetermined period is a period of time selected from a range of 1 minute to 60 minutes.

7. The method as recited in claim 1, wherein the predetermined period is 40 minutes.

8. The method as recited in claim 1, wherein the secured space comprises a container at the delivery site.

9. A package delivery system, comprising:
a delivery communicator configured for communicating to a package database a temporal characteristic associated with a proximate delivery of a package having a package code identifying the package to be delivered at a delivery site;
a delivery service network communicator for receiving the communication from the delivery communicator and recording in a delivery database the temporal characteristic in association with the package code;
a data receiver of a secure container at the delivery site for receiving an entry of the package code as a request to open the secure container;
a network communicator of the secure container communicating the package code to the delivery service network communicator and receiving from the delivery service network communicator a confirmation of a determination that entry of the package code to the data receiver is within a predetermined period of the temporal characteristic associated with the package code; and
a releasable latch biased to a locked position securing the secure container from opening selectively moved to an unlocked position to allow opening the secured container for receiving the package.

10. The package delivery system as recited in claim 9, wherein the data receiver comprises a scanner device for receiving entry of the package code.

11. The package delivery system as recited in claim 10, wherein the secure container further comprises a motion sensor that upon detecting proximate motion actives the scanner device.

12. The package delivery system as recited in claim 11, further comprising a video imaging device activated by the motion sensor upon detecting proximate motion, for imaging for a predetermined imaging period.

13. The package delivery system as recited in claim 12, further comprising storing the imaging in a database and including the date and time of the imaging.

14. The package delivery system as recited in claim 9, further comprising a key by which the releasable latch is selectively moved to the unlocked position.

15. The package delivery system as recited in claim 14, wherein the key comprises a coded identifier maintained on and displayed a mobile communication device, whereby upon display of the coded identifier to the scanner a controller of the secure container moves the releasable latch from the locked position to the unlocked position.

16. The package delivery system as recited in claim 14, wherein the coded identifier is generated during a secure container registration.

17. The package delivery system as recited in claim 14, wherein the key is generated by a controller and transferred to the mobile communications device.

18. The package delivery system as recited in claim 14, wherein the key is valid for a single use on the mobile communications device.

19. A container for receiving delivery of a package, comprising:
a secure container selectively opened for receiving delivery of a package at a delivery site;
a data receiver for receiving an entry of a package code identifying a package for delivery, said entry for requesting the secure container to open;
a container network communicator;
a releasable latch biased to a locked position securing the secure container from opening and selectively moved to an unlocked position to allow opening the secured container for receiving the package in response to a key;
a controller for (a) communicating with the container network communicator a time code associated with the entry of the package code to a package tracking database for each of a plurality of packages identified by a respective package code and having an associated temporal characteristic of a respective proximate delivery time of the package to be delivered at a delivery site and (b) receiving a confirmation of a determination that entry of the package code is within a predetermined period of the temporal characteristic associated with the package code, whereby the controller causes the releasable latch to move to the unlocked position for opening the secured container for receiving the package.

20. The container for receiving delivery of a package as recited in claim 19, wherein the predetermined period is a period of time selected from a range of 1 minute to 60 minutes.

21. The container for receiving delivery of a package as recited in claim 19, wherein the predetermined period is 40 minutes.

22. The container as recited in claim 19, wherein the data receiver comprises a scanner device for imaging a scan code.

23. The container as recited in claim 19, further comprising a motion detector for activating the data receiver.

24. The container as recited in claim 19, further comprising an imaging device for imaging for a predetermined period upon entry of the package code identifying the package for delivery.

25. The container as recited in claim 24, further comprising a database for storing the imaging.

26. The container as recited in claim 19, further comprising a display screen for displaying a key code generated by the controller for imaging with a mobile communications device for use in subsequent requests to open the container; and wherein the controller further configured to receive the key and upon verification for causing the releasable latch to move to the unlocked position for opening the secured container.
